(19) United States
(12) Patent Application Publication
(10) Pub. No.: US 2023/0073050 A1
(43) Pub. Date: Mar. 9, 2023

(54) CROSSLINKABLE COMPOSITION COMPRISING A MONO(METH)ACRYLATE HAVING A 1,3 DIOXOLANE RING

(71) Applicant: Arkema France, Colombes (FR)

(72) Inventors: Christophe Duquenne, Verneuil En Halatte (FR); Kevin Demoulin, Verneuil En Halatte (FR)

(21) Appl. No.: 17/789,305

(22) PCT Filed: Dec. 22, 2020
(86) PCT No.: PCT/EP2020/087606

§ 371 Date: Jun. 27, 2022

(30) Foreign Application Priority Data
Dec. 31, 2019 (FR) FR1915759

(51) Int. Cl. C08L 67/04; B33Y 70/00; C08L 33/06; C08L 33/14; C08K 5/5313; C08K 5/14; B33Y 10/00

(52) U.S. Cl. CPC C08L 67/04; B33Y 70/00; C08L 33/06; C08L 33/14; C08K 5/5313; C08K 5/14; B33Y 10/00; C08L 2312/06

(57) ABSTRACT

The present invention relates to a crosslinkable composition comprising a mono(meth)acrylate comprising a 1,3-dioxolane ring, another mono(meth)acrylate and also a (meth)acrylated oligomer. The invention also relates to a process for producing a crosslinked product, in particular a 3D object, from this composition, and also to the use of this composition for obtaining an ink, a coating, a sealant, an adhesive, a molded material, an inking plate or a 3D object. The invention further relates to the use of a mono(meth)acrylate having a 1,3-dioxolane ring in a composition for 3D printing.

### TECHNICAL FIELD

The present invention relates to a crosslinkable composition comprising a mono(meth)acrylate comprising a 1,3-dioxolane ring, another mono(meth)acrylate and also a (meth)acrylated oligomer. The invention also relates to a process for producing a crosslinked product, in particular a 3D object, from this composition, and also to the use of this composition for obtaining an ink, a coating, a sealant, an adhesive, a molded material, an inking plate or a 3D object. The invention further relates to the use of a mono(meth)acrylate having a 1,3-dioxolane ring in a composition for 3D printing.

### PRIOR ART

Crosslinkable compositions, in particular radiation-crosslinkable compositions, are commonly used to obtain inks, coatings and also 3D objects. Depending on the intended applications, the compositions must have advantageous properties in terms of viscosity, hardness, breaking strength and/or elasticity.

It is well known that the introduction of mono(meth)acrylates into a crosslinkable composition makes it possible to reduce the viscosity of the composition without the addition of solvent. During the crosslinking, these diluents react with the other polymerizable compounds, but do not participate in establishing crosslinking points in the system. Thus, the incorporation thereof can be detrimental to the mechanical properties of the product obtained.

The mono(meth)acrylate monomers that will be added to crosslinkable compositions should thus be chosen carefully.

After a great deal of research, the applicant has selected a particular mono(meth)acrylate monomer, namely a mono(meth)acrylate having a 1,3-dioxolane ring, for its balanced properties. This monomer, when it is combined with another mono(meth)acrylate and with a (meth)acrylated oligomer, in specific proportions, makes it possible to obtain crosslinkable compositions having advantageous properties in terms of viscosity, hardness, breaking strength and/or elasticity. These compositions are in particular of use for obtaining an ink, a coating, a sealant, an adhesive, an inking plate or a molded material. Advantageously, the crosslinkable compositions can be used in 3D printing.

Certain 3D printing techniques subject the printed object to considerable deformations. This is in particular the case for in-tank processes when the mobile platform gradually rises (“bottom-up” process). This is because the successive layers of the object are subjected to adhesion forces that must be broken at the time the object being constructed is raised in order to go to the next layer, in particular the suction effect between the printed layer and the bottom of the tank. In particular, for resins intended to produce flexible and/or elastomeric objects, which are by definition more sensitive to deformation forces, this suction effect between the printed layer and the tank bottom can destroy the newly formed layer that remains fragile. Objects in which the center is hollowed out are observed. It is necessary to improve this aspect either by reinforcing the cohesion of the layers or by reducing the affinity of the polymerized resin with the material of the tank bottom.

By varying the soft/hard and/or hydrophilic/hydrophobic nature of the mono(meth)acrylate that is combined with the mono(meth)acrylate having a 1,3-dioxolane ring, it is possible to use the crosslinkable composition in most 3D printing techniques, in particular tank printing or inkjet printing, in order to obtain 3D objects having advantageous mechanical properties. It is in particular possible to obtain flexible and/or elastomeric 3D objects.

### SUMMARY OF THE INVENTION

A subject of the invention is thus a composition comprising:

a) 5 to less than 50%, in particular 10 to 40%, more particularly 15 to 30%, of a component A) which is a mono(meth)acrylate comprising a 1,3-dioxolane ring;

b) 10 to 75%, in particular 15 to 70%, more particularly 20 to 60%, of a component B) which is a mono(meth)acrylate different from A);

c) 0 to less than 45%, in particular 1 to 40%, more particularly 2 to 20%, of a component C) which is a di(meth)acrylate having a weight-average molecular weight Mw of less than or equal to 650 g/mol;

d) 0 to 30%, in particular 0 to 20%, of a component D) which is a tri(meth)acrylate having a weight-average molecular weight Mw of less than or equal to 600 g/mol;

e) 0 to 30%, in particular 0 to 20%, of a component E) which is a tetra(meth)acrylate having a weight-average molecular weight Mw of less than or equal to 600 g/mol;

f) 5 to 80%, in particular 8 to 55%, more particularly 15 to 40%, of a component F) which is an oligomer comprising at least two (meth)acrylate groups and having a weight-average molecular weight Mw of greater than 700 g/mol;

g) 0 to 30%, in particular 0 to 20%, of a component G) which is an additional monomer;

h) 0.5 to 10% of a component H) which is an initiator;

i) 0 to 30% of a component I) which is an additive;

the % being % by weight relative to the weight of all the components A) to I);

on the condition that the total weight of the components A) and C) represents less than 50% of the weight of all the components A) to I).

Another subject of the invention is a process for producing a crosslinked product, the process comprising the crosslinking of the composition according to the invention, in particular by exposing the composition to radiation, more particularly to UV, near-UV, visible, infrared or near-infrared rays or to an electron beam.

Another subject of the invention is a process for producing a 3D object, comprising the printing of a 3D object using the composition according to the invention; in particular the continuous or layer-by-layer printing of a 3D object.

Another subject of the invention is a crosslinked product obtained by crosslinking the composition according to the invention or obtained using the process according to the invention.

The invention also relates to the use of the composition according to the invention for obtaining an ink, a coating, a sealant, an adhesive, a molded material, an inking plate or a 3D object, in particular a 3D object.

Another subject of the invention is the use of a mono(meth)acrylate comprising a 1,3-dioxolane ring in a composition for 3D printing.

### DESCRIPTION OF THE EMBODIMENTS

### Definitions

In the present application, the term “comprises a” means “comprises one or more”. Unless otherwise mentioned, the weight percentages in a compound or a composition are expressed relative to the weight of the compound, respectively of the composition.

The term “1,3-dioxolane” means a ring of 5 atoms, including two oxygen atoms, the two oxygen atoms being separated by a carbon atom.

The term “(meth)acrylate” means acrylate or methacrylate. Preferably, the (meth)acrylate is an acrylate. The term “acrylate” means an acryloyloxy group (—O—C(═O)—CH═CH₂). The term “methacrylate” means a methacryloyloxy group (—O—C(═O)—C(CH₃)═CH₂).

The term “mono(meth)acrylate” means a compound having a single (meth)acrylate group. In particular, the mono(meth)acrylate is a monoacrylate having a single acrylate group.

The term “di(meth)acrylate” means a compound having two (meth)acrylate groups. In particular, the di(meth)acrylate is a diacrylate having two acrylate groups.

The term “tri(meth)acrylate” means a compound having three (meth)acrylate groups. In particular, the tri(meth)acrylate is a triacrylate having three acrylate groups.

The term “tetra(meth)acrylate” means a compound having four (meth)acrylate groups. In particular, the tetra(meth)acrylate is a tetraacrylate having four acrylate groups.

The term “alkyl” means a monovalent saturated acyclic hydrocarbon-based radical of formula —CₙH₂ₙ₊₁. An alkyl can be linear or branched. A “C₁-C₆ alkyl” means an alkyl comprising 1 to 6 carbon atoms. Examples of alkyl groups are methyl, ethyl, propyl, isopropyl, butyl, isobutyl, tert-butyl, pentyl and hexyl.

The term “cycloalkyl” means a monovalent saturated hydrocarbon-based radical comprising a ring. A “C₅-C₁₂ cycloalkyl” means a cycloalkyl comprising 5 to 12 carbon atoms. Examples of cycloalkyl groups are cyclopentyl, cyclohexyl and isobornyl.

The term “alkylaryl” means an alkyl substituted with an aromatic group such as a phenyl group. An example of alkylaryl is the benzyl group (—CH₂-Phenyl).

The term “alkylene” means a divalent saturated acyclic hydrocarbon-based radical of formula —CₙH₂ₙ—. An alkylene can be linear or branched. A “C₁-C₁₂ alkylene” means an alkylene comprising 1 to 12 carbon atoms.

The term “oxyalkylene” means a divalent group having one or more —O—CₙH₂ₙ— units with n ranging from 2 to 4.

The term “monoalcohol” means a compound having a single hydroxyl function.

The term “polyol” means a compound having at least two hydroxyl functions. The functionality of a polyol corresponds to the number of hydroxyl functions that it contains.

The term “polyester” means a compound comprising at least two ester bonds.

The term “polyether” means a compound comprising at least two ether bonds.

The term “polycarbonate” means a compound comprising at least two carbonate bonds.

The term “polyester polyol” means a polyester comprising at least two hydroxyl functions.

The term “polyether polyol” means a polyether comprising at least two hydroxyl functions.

The term “polycarbonate polyol” means a polycarbonate comprising at least two hydroxyl functions.

The term “hydrocarbon-based chain” means a chain comprising only carbon and hydrogen atoms. Unless otherwise mentioned, a hydrocarbon-based chain is neither substituted nor interrupted with a heteroatom. A hydrocarbon-based chain may be linear or branched, saturated or unsaturated, aliphatic, cycloaliphatic or aromatic. A “C₄-C₂₄ hydrocarbon-based chain” is a hydrocarbon-based chain comprising 4 to 24 carbon atoms.

The term “hydroxyl function” means an —OH function.

The term “carboxylic acid function” means a —COOH function.

The term “isocyanate function” means an —N═C═O function.

The term “ester bond” means a —C(═O)—O— or —O—C(═O)— bond.

The term “ether bond” means an —O— bond.

The term “carbonate bond” means an —O—C(═O)—O— bond.

The term “urethane bond” means an —NH—C(═O)—O— or —O—C(═O)—NH— bond.

The term “amide bond” means a —C(═O)—NH— or —NH—C(═O)— bond.

The term “urea bond” means an —NH—C(═O)—NH— bond.

A “soft” compound means a compound having a Tg of −100 to 24° C. A “hard” compound means a compound having a Tg of 25 to 200° C. The Tg of a monomer can in particular be measured on the corresponding homopolymer according to the method described below.

A hydrophilic mono(meth)acrylate means a mono(meth)acrylate comprising one or more oxygen and/or nitrogen atoms in addition to the oxygen atoms contained in the (meth)acrylate group. A hydrophilic mono(meth)acrylate can in particular have Hansen solubility parameters δp and δh corresponding to the following equation: δh≥30.5−2.2×δp. The parameters δh and δp can be calculated according to the method described in “Hansen Solubility Parameters: a user's handbook” by Charles M. Hansen (Chapter I, Table 1.1) (ISBN 068494-1525-5). In particular, a hydrophilic mono(meth)acrylate may comprise an element chosen from a hydroxyl group (—OH), a primary or secondary amino group (—NH₂ or —NH(C₁-C₆ alkyl)), an alkoxylated chain (comprising at least one —[O—(C₁-C₆ alkylene)]- unit), an oxygen-comprising or nitrogen-comprising heterocycle, a urethane function, a urea function, an ester function, an amide function, a carboxylic acid function, an ether function, a carbonate function, and mixtures thereof.

The term “hydrophobic mono(meth)acrylate” means a mono(meth)acrylate not comprising a nitrogen atom or oxygen atom other than the oxygen atoms contained in the (meth)acrylate group. A hydrophobic mono(meth)acrylate can in particular have Hansen solubility parameters δp and δh corresponding to the following equation: δh<30.5-2.2×δp. In particular, a hydrophobic mono(meth)acrylate can comprise an element chosen from a C₄-C₂₄ hydrocarbon-based chain.

The term “ethylenically unsaturated” means a compound comprising a polymerizable carbon-carbon double bond. A polymerizable carbon-carbon double bond is a carbon-carbon double bond that can react with another carbon-carbon double bond in a polymerization reaction. A polymerizable carbon-carbon double bond is generally included in an acryloyloxy (—O—C(═O)—CH═CH₂), methacryloyloxy (—O—C(═O)—C(CH₃)═CH₂), vinyl (—CH═CH₂) or allyl (—CH₂—CH═CH₂) group. The carbon-carbon double bonds of a phenyl ring are not considered to be polymerizable carbon-carbon double bonds.

The term “polyisocyanate” means a compound having at least two isocyanate functions.

The term “aliphatic” means a non-aromatic acyclic compound. It may be linear or branched, and saturated or unsaturated. It may be substituted with one or more groups/functions, for example chosen from alkyl, hydroxyl, halogen (Br, CI, I), isocyanate, carbonyl, amine, carboxylic acid, a sulfonylated group (—S(═O)₂OR), a phosphonylated group (—P(═O)(OR)₂), a sulfated group (—O—S(═O)₂OR), a phosphated group (—O—P(═O)(OR)₂), —C(═O)—OR′, —C(═O)—O—C(═O)—R′, each R being independently a hydrogen atom, a metal salt or a hydrocarbon-based chain optionally substituted or interrupted with a heteroatom and R′ being a C₁-C₆ alkyl, and mixtures thereof. It may comprise one or more bonds/functions, for example chosen from ether, ester, amide, urethane, urea, and mixtures thereof.

The term “cycloaliphatic” means a non-aromatic cyclic compound. It may be substituted with one or more groups/functions as defined for the term “aliphatic”. It may comprise one or more bonds/functions as defined for the term “aliphatic”.

The term “aromatic” means a compound comprising an aromatic ring, that is to say obeying Hückel's rule of aromaticity, in particular a compound comprising a phenyl group. It may be substituted with one or more groups/functions as defined for the term “aliphatic”. It may comprise one or more bonds/functions as defined for the term “aliphatic”.

The term “saturated” means a compound which does not comprise a carbon-carbon double or triple bond.

The term “unsaturated” means a compound which comprises a carbon-carbon double or triple bond, in particular a carbon-carbon double bond.

The term “polycarboxylic acid” means a compound comprising at least two carboxylic acid functions.

The term “3D object” means a three-dimensional object obtained by 3D printing.

The term “inking plate” means a relief plate intended for printing, in particular in flexography.

Component A)

The composition according to the invention comprises a component A). The composition may comprise a mixture of components A).

The component A) is a mono(meth)acrylate comprising a 1,3-dioxolane ring. Preferably, the component A) is a monoacrylate comprising a 1,3-dioxolane ring.

The component A) can in particular correspond to formula (I) below:

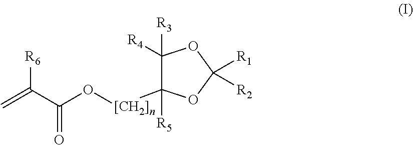

in which

R₁ and R₂ are independently chosen from H, C₁-C₆ alkyl, C₅-C₁₂ cycloalkyl and alkylaryl;

R₃, R₄, R₅ and R₆ are independently H or methyl;

n is 1, 2, 3, 4 or 5.

R₁ and R₂ can be independently chosen from H, methyl, ethyl, propyl, isopropyl, butyl, isobutyl, tert-butyl, cyclohexyl, isobornyl and benzyl. In particular, R₁ and R₂ are independently chosen from H, methyl and ethyl. More particularly, R₁ and R₂ are methyl.

Preferably, R₃, Ra and R₅ are H.

R₆ can be H or methyl. In particular, R₆ is H.

Preferably, n is 1.

According to one preferred embodiment, the component A) corresponds to formula (I) above, in which

R₁ and R₂ are independently chosen from H, methyl and ethyl, preferably R₁ and R₂ are methyl;

R₃, R₄ and R₅ are H;

R₆ is H or methyl, preferably R₆ is H;

n is 1.

Suitable examples of components A) are (2,2-dimethyl-1,3-dioxolan-4-yl)methyl acrylate, (2-ethyl-2-methyl-1,3-dioxolan-4-yl)methyl acrylate and glycerol formal methacrylate.

Advantageously, the component A) is (2,2-dimethyl-1,3-dioxolan-4-yl)methyl acrylate represented by formula (Ia) below:

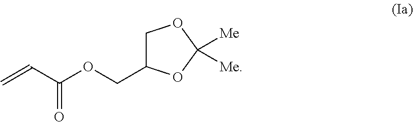

The composition according to the invention comprises 5 to less than 50%, in particular 10 to 40%, more particularly 15 to 30%, by weight of component A) relative to the weight of all the components A) to I).

Component B)

The composition according to the invention comprises a component B). The composition may comprise a mixture of components B). According to one particular embodiment, the composition comprises one, two or three distinct components B).

The component B) is a mono(meth)acrylate different from the component A). Preferably, the component B) is a monoacrylate different from the component A). More preferentially, the component B) is a mixture of monoacrylates different from the component A).

The component B) can in particular correspond to formula (II) below:

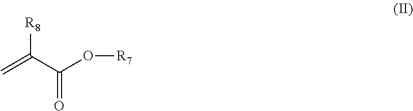

in which

R₇ is the residue of a monoalcohol or polyol chosen from a monoalcohol or polyol of polyether type, a monoalcohol or polyol of polyester type, a monoalcohol or polyol of polycarbonate type, an aliphatic monoalcohol or polyol, a cycloaliphatic monoalcohol or polyol, an aromatic monoalcohol or polyol, and the alkoxylated, in particular ethoxylated and/or propoxylated, derivatives of said monoalcohols or polyols;

R₈ is H or methyl, in particular R₈ is H.

The component B) can in particular be chosen from a soft and hydrophilic mono(meth)acrylate, a soft and hydrophobic mono(meth)acrylate, a hard and hydrophilic mono(meth)acrylate, a hard and hydrophobic mono(meth)acrylate, and mixtures thereof.

According to one particular embodiment, the component B) comprises a soft and hydrophilic mono(meth)acrylate. The component B) can in particular comprise a mixture of soft and hydrophilic mono(meth)acrylates. More particularly, the component B) can comprise a soft and hydrophilic mono(meth)acrylate chosen from 2-hydroxyethyl acrylate, 2-hydroxypropyl acrylate, 4-hydroxybutyl acrylate, diethylene glycol monoacrylate, diethylene glycol monomethacrylate, triethylene glycol monoacrylate, triethylene glycol monomethacrylate, polyethylene glycol monoacrylate, polyethylene glycol monomethacrylate, methoxypolyethylene glycol monoacrylate, methoxypolyethylene glycol monomethacrylate (in particular available under the references SR550 and SR552 from Arkema), polypropylene glycol monoacrylate, polypropylene glycol monomethacrylate (in particular available under the reference SR604 from Arkema), 2-ethoxyethyl acrylate, 2-(2-ethoxyethoxy)ethyl acrylate (in particular available under the reference SR256 from Arkema), a polycaprolactone monoacrylate (in particular available under the reference SR495B from Arkema), tetrahydrofurfuryl acrylate (in particular available under the reference SR285 from Arkema), tetrahydrofurfuryl methacrylate (in particular available under the reference SR203H from Arkema), 2-phenoxyethyl acrylate (in particular available under the reference SR339C from Arkema), an ethoxylated phenyl acrylate (in particular available under the reference SR410 from Arkema), (5-ethyl-1,3-dioxan-5-yl)methyl acrylate (CTFA in particular available under the reference SR531 from Arkema), 2-[[(butylamino)carbonyl]oxy]ethyl acrylate (in particular available under the reference Genomer® 1122 from Rahn), and mixtures thereof.

According to one preferred embodiment, the component B) comprises a soft and hydrophilic mono(meth)acrylate comprising a hydroxyl group, preferably a soft and hydrophilic monoacrylate comprising a hydroxyl group, more preferentially a polycaprolactone monoacrylate. A polycaprolactone mono(meth)acrylate can in particular correspond to the formula below:

HO—[(CH₂)₅—C(═O)—O]ₓ-L-O—C(═O)—CR′═CH₂

in which

L is an alkylene or an oxyalkylene, preferably L is —(CH₂)₂—

R′ is H or methyl, preferably R′ is H;

x is 1 to 10, preferably 1 to 6.

An advantageous polycaprolactone monoacrylate is a polycaprolactone monoacrylate comprising 1, 2 or 3, in particular 2, —[(CH₂)₅—C(═O)—O]— units. A polycaprolactone acrylate comprising 2-[(CH₂)₅—C(═O)—O]— units is sold under the reference SR495B by Arkema.

According to one particular embodiment, the component B) comprises a soft and hydrophobic mono(meth)acrylate. More particularly, the component B) comprises a soft and hydrophobic mono(meth)acrylate chosen from octyl/decyl acrylate (in particular available under the reference SR484 from Arkema), iso-decyl acrylate (in particular available under the reference SR395 from Arkema), dodecyl acrylate (in particular available under the reference SR335 from Arkema), tridecyl acrylate (in particular available under the reference SR489 from Arkema), stearyl acrylate (in particular available under the reference SR586 from Arkema), behenyl acrylate (in particular available under the reference SR587 from Arkema), 2-ethylhexyl acrylate, 2-ethylhexyl methacrylate, butyl acrylate, butyl methacrylate, iso-butyl acrylate, heptadecyl acrylate, propylheptyl acrylate, dodecyl methacrylate (in particular available under the reference SR313A from Arkema), benzyl acrylate, cyclohexyl acrylate, and mixtures thereof.

According to one particular embodiment, the component B) comprises a hard and hydrophilic mono(meth)acrylate. More particularly, the component B) can comprise a hard and hydrophilic mono(meth)acrylate chosen from acrylic acid, 2-carboxyethyl acrylate, methacrylic acid, 2-hydroxypropyl methacrylate, 2-hydroxyethyl methacrylate, acryloyl morpholine, 2-phenoxyethyl methacrylate (in particular available under the reference SR340 from Arkema), and mixtures thereof.

According to one particular embodiment, the component B) comprises a hard and hydrophobic mono(meth)acrylate. More particularly, the component B) comprises a hard and hydrophobic mono(meth)acrylate chosen from tert-butylcyclohexyl acrylate (in particular available under the reference SR217 from Arkema), tert-butylcyclohexyl methacrylate (in particular available under the reference SR218 from Arkema), trimethylcyclohexyl acrylate (in particular available under the reference SR420 from Arkema), trimethylcyclohexyl methacrylate (in particular available under the reference SR421A from Arkema), isobornyl acrylate (in particular available under the reference SR506D from Arkema), isobornyl methacrylate (in particular available under the reference SR423D from Arkema), tert-butyl acrylate, tert-butyl methacrylate, cyclohexyl methacrylate, benzyl methacrylate, tricyclodecane methanol monoacrylate (in particular available under the reference SR789 from Arkema), and mixtures thereof.

According to one particular embodiment, the component B) comprises a soft and hydrophilic mono(meth)acrylate, optionally as a mixture with a hard and hydrophobic mono(meth)acrylate. More particularly, the component B) comprises a soft and hydrophilic monoacrylate, optionally as a mixture with a hard and hydrophobic monoacrylate.

Advantageously, the component B) comprises at least 15% by weight, in particular 20 to 100%, more particularly 25 to 60%, by weight of soft and hydrophilic mono(meth)acrylate relative to the weight of the component B).

The component B) can in particular comprise a soft and hydrophilic monoacrylate comprising a hydroxyl group, in particular a polycaprolactone acrylate, optionally as a mixture with a monoacrylate having a Tg of greater than 40° C., in particular isobornyl acrylate. This embodiment is particularly suitable for a crosslinkable composition for obtaining flexible and/or elastomeric 3D objects.

Alternatively, the component B) can comprise a mono(meth)acrylate having a low surface tension. The surface tension can in particular be from 20 to 35 mN/m, in particular from 25 to 32 mN/m, as measured according to the method described below. Examples of mono(meth)acrylates having a low surface tension are tert-butyl cyclohexyl acrylate, isobornyl acrylate, tricyclodecane methanol monoacrylate, isodecyl acrylate, 3,5,5-trimethylcyclohexyl acrylate, 3,5,5-trimethylcyclohexyl methacrylate, 2-ethylhexyl acrylate, isooctyl acrylate, octyldecyl acrylate, tridecyl acrylate, lauryl acrylate, ethoxylated lauryl acrylate (4 ethoxy units), isodecyl methacrylate, tert-butylcyclohexyl methacrylate, isobornyl methacrylate, tricyclodecane methanol monomethacrylate and a C₁₂-C₁₅ alkyl methacrylate such as lauryl methacrylate. More particularly, the component B) may be isobornyl acrylate. This embodiment is particularly suitable for a crosslinkable composition for obtaining 3D objects by ink printing.

The composition according to the invention comprises 10 to 75%, in particular 15 to 70%, more particularly 20 to 60%, by weight of component B) relative to the weight of all the components A) to I).

Component C)

The composition according to the invention may comprise a component C). The composition may comprise a mixture of components C).

The component C) is a di(meth)acrylate. In particular, the component C) is a diacrylate.

The component C) has a weight-average molecular weight Mw of less than or equal to 650 g/mol. In particular, the component C) has a Mw of from 100 to 600 g/mol, more particularly from 200 to 500 g/mol.

The component C) can in particular correspond to formula (III) below:

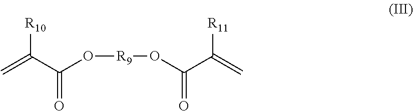

in which

R₉ is the residue of a polyol chosen from a polyether polyol, a polyester polyol, a polycarbonate polyol, an aliphatic polyol, a cycloaliphatic polyol, an aromatic polyol, a polybutadiene polyol, a polydialkylsiloxane polyol and the alkoxylated, in particular ethoxylated and/or propoxylated, derivatives of said polyols;

R₁₀ and R₁₁ are independently H or methyl, in particular R₁₀ and R₁₁ are H.

According to one particular embodiment, R₉ is the residue of a polyether polyol or of an aliphatic polyol that is optionally alkoxylated, in particular ethoxylated and/or propoxylated. More particularly, R₉ is the residue of a polyethylene glycol.

A component C) having a polyether polyol residue can in particular correspond to formula (IIIa) below:

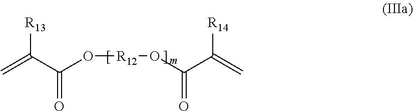

in which each R₁₂ is independently a C₂-C₄ alkylene, in particular each R₁₂ is independently ethylene, propylene or butylene;

R₁₃ and R₁₄ are independently H or methyl, in particular R₁₃ and R₁₄ are H;

m ranges from 2 to 15.

The component C) can in particular be a polyethylene glycol diacrylate corresponding to formula (IIIa) in which

R₁₂ is an ethylene;

R₁₃ and R₁₄ are H;

m ranges from 7 to 12, in particular m is 9.

An example of a suitable polyethylene glycol diacrylate of formula (IIIa) with m=9 is available under the reference SR344 from Arkema.

A component C) having an optionally alkoxylated aliphatic polyol residue may in particular correspond to formula (IIIb) below:

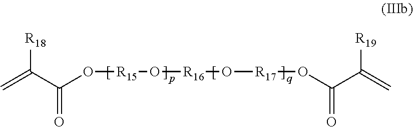

in which each R₁₅ and R₁₇ is independently a C₂-C₄ alkylene, in particular each R₁₅ and R₁₇ is independently ethylene, propylene or butylene;

R₁₆ is a C₁-C₁₂ alkylene;

R₁₈ and R₁₉ are independently H or methyl, in particular R₁₈ and R₁₉ are H; p and q, which may be identical or different, range from 0 to 10 and p+q ranges from 0 to 10.

According to one particular embodiment, the component C) corresponds to formula (III) in which

R₉ is the residue of a polyol chosen from ethylene glycol, 1,2-propanediol, 1,3-propanediol, 1,4-butanediol, 1,3-butanediol, 1,5-pentanediol, 1,6-hexanediol, 3-methyl-1,5-pentanediol, 1,10-decanediol, 1,12-dodecanediol, diethylene glycol, triethylene glycol, dipropylene glycol, tripropylene glycol, dibutylene glycol, tributylene glycol, a polyethylene glycol, a polypropylene glycol, a polybutylene glycol, 1,4-cyclohexanedimethanol, 1,6-cyclohexanedimethanol, 1,4-cyclohexanediol, bisphenol A, hydrogenated bisphenol A, glycerol, diglycerol, a polyglycerol, tricyclodecane dimethanol, trimethylolpropane, di(trimethylolpropane), trimethylolethane, 1,2,6-hexanetriol, 1,2,4-butanetriol, erythritol, pentaerythritol, di(pentaerythritol), neopentyl glycol, 2-methyl-1,3-propanediol, sorbitol, mannitol, xylitol, isosorbide, isoidide, isomannide, methyl glucoside, a polybutadiene with a hydroxyl end group, a polydialkylsiloxane with an alkylhydroxy end group, and also the alkoxylated, in particular ethoxylated and/or propoxylated, derivatives of said polyols;

R₁₀ and R₁₁ are independently H or methyl, in particular R₁₀ and R₁₁ are H.

The composition according to the invention comprises 0 to less than 45%, in particular 1 to 40%, more particularly 2 to 20%, by weight of component C) relative to the weight of all the components A) to I).

Component D)

The composition according to the invention may comprise a component D). The composition may comprise a mixture of components D).

The component D) is a tri(meth)acrylate. In particular, the component D) is a triacrylate.

The component D) has a weight-average molecular weight Mw of less than or equal to 600 g/mol. In particular, the component D) has a Mw of from 100 to 550 g/mol, more particularly from 200 to 500 g/mol.

The component D) can in particular correspond to formula (IV) below:

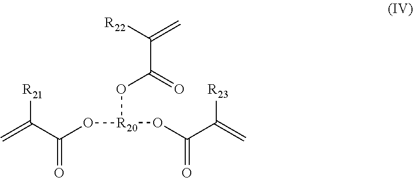

in which

R₂₀ is the residue of a polyether polyol or of an aliphatic polyol that is optionally alkoxylated, in particular ethoxylated and/or propoxylated, in particular R₂₀ is the residue of a polyol chosen from trimethylolpropane, di(trimethylolpropane), trimethylolethane, 1,2,6-hexanetriol, 1,2,4-butanetriol, erythritol, pentaerythritol, di(pentaerythritol), glycerol, diglycerol, a polyglycerol, sorbitol, mannitol, xylitol, methyl glucoside, an isocyanurate, and the alkoxylated, in particular ethoxylated and/or propoxylated, derivatives of said polyols;

R₂₁, R₂₂ and R₂₃ are independently H or methyl, in particular R₂₁, R₂₂ and R₂₃ are H.

The composition according to the invention comprises 0 to 30%, in particular 0 to 20%, by weight of component D) relative to the weight of all the components A) to I).

Component E)

The composition according to the invention may comprise a component E). The composition may comprise a mixture of components E).

The component E) is a tetra(meth)acrylate. In particular, the component E) is a tetraacrylate.

The component E) has a weight-average molecular weight Mw of less than or equal to 600 g/mol. In particular, the component E) has a Mw of from 200 to 550 g/mol, more particularly from 300 to 500 g/mol.

The component E) can in particular correspond to formula (V) below:

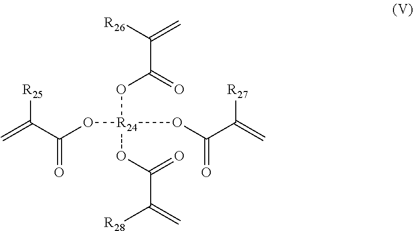

in which

R₂₄ is the residue of an alkoxylated, in particular ethoxylated and/or propoxylated, aliphatic polyol, in particular R₂₄ is the residue of a polyol chosen from di(trimethylolpropane), pentaerythritol, di(pentaerythritol), and the alkoxylated, in particular ethoxylated and/or propoxylated, derivatives of said polyols;

R₂₅, R₂₆, R₂₇ and R₂₈ are independently H or methyl, in particular R₂₅, R₂₆, R₂₇ and R₂₈ are H.

The composition according to the invention comprises 0 to 30%, in particular 0 to 20%, by weight of component E) relative to the weight of all the components A) to I).

Component F)

The composition according to the invention comprises a component F). The composition may comprise a mixture of components F).

The component F) is an oligomer comprising at least two (meth)acrylate groups. In particular, the component F) is an oligomer comprising at least two acrylate groups. The component F) can in particular be an oligomer comprising 2 to 10, in particular from 2 to 6, more particularly 2 to 4, (meth)acrylate groups. The component F) can in particular be an oligomer comprising 2 to 10, in particular from 2 to 6, more particularly 2 to 4, acrylate groups.

The component F) has a weight-average molecular weight Mw of greater than 700 g/mol. In particular, the component F) has a Mw of from 750 to 10 000 g/mol, more particularly from 1000 to 3000 g/mol.

The component F) can in particular be an oligomer chosen from a urethane (meth)acrylate, an epoxy (meth)acrylate, a polyether (meth)acrylate and a polyester (meth)acrylate. Advantageously, the component F) is an oligomer chosen from a urethane acrylate, an epoxy acrylate, a polyether acrylate, a polyester acrylate, and mixtures thereof.

Examples of suitable epoxy (meth)acrylates include the reaction products of acrylic acid, of methacrylic acid or of a mixture thereof with an epoxy resin (polyglycidyl ether or ester). The epoxy resin can, in particular, be chosen from bisphenol A diglycidyl ether; bisphenol F diglycidyl ether; bisphenol S diglycidyl ether; brominated bisphenol A diglycidyl ether; brominated bisphenol F diglycidyl ether; brominated bisphenol S diglycidyl ether; hydrogenated bisphenol A diglycidyl ether; hydrogenated bisphenol F diglycidyl ether;

hydrogenated bisphenol S diglycidyl ether; novolac epoxy resin; 3,4-epoxycyclohexylmethyl-3′,4′-epoxycyclohexanecarboxylate; 2-(3,4-epoxycyclohexyl-5,5-spiro-3,4-epoxy)cyclohexane-1,4-dioxane; bis(3,4-epoxycyclohexylmethyl)adipate; vinylcyclohexene diepoxide; 4-vinylepoxycyclohexane; bis(3,4-epoxy-6-methylcyclohexylmethyl)adipate; 3,4-epoxy-6-methylcyclohexyl-3′,4′-epoxy-6′-methylcyclohexanecarboxylate; methylenebis(3,4-epoxycyclohexane); dicyclopentadiene diepoxide; di(3,4-epoxycyclohexylmethyl) ether of ethylene glycol; ethylenebis(3,4-epoxycyclohexanecarboxylate); 1,4-butanediol diglycidyl ether; 1,6-hexanediol diglycidyl ether; glycerol triglycidyl ether; trimethylolpropane triglycidyl ether; polyethylene glycol diglycidyl ether; polypropylene glycol diglycidyl ether; polyglycidyl ethers of a polyether polyol obtained by addition of one or more alkylene oxides to an aliphatic polyhydric alcohol, such as in particular ethylene glycol, propylene glycol and glycerol; diglycidyl esters of long-chain aliphatic basic diacids; monoglycidyl ethers of aliphatic alcohols; monoglycidyl ethers of phenol, cresol, butylphenol, or of alkoxylated derivatives thereof; glycidyl esters of fatty acids; epoxidized soybean oil; epoxybutylstearic acid; epoxyoctylstearic acid; epoxidized linseed oil; and epoxidized polybutadiene.

Examples of suitable urethane (meth)acrylates (also called “polyurethane (meth)acrylates”) include urethanes based on polyester polyols, polyether polyols or polycarbonate polyols that are aliphatic, cycloaliphatic and/or aromatic, and on aliphatic, cycloaliphatic and/or aromatic diisocyanates. The urethane (meth)acrylates can in particular be prepared by reacting an aliphatic, cycloaliphatic and/or aromatic polyisocyanate (for example a diisocyanate or triisocyanate) with a polyester polyol, polyether polyol, polycarbonate polyol, polycaprolactone polyol, polydimethysiloxane polyol, polybutadiene polyol or a mixture thereof, in order to form an oligomer functionalized with isocyanate groups, which is then reacted with a (meth)acrylate comprising a hydroxyl group, such as hydroxyethyl (meth)acrylate or hydroxypropyl (meth)acrylate, in order to introduce the (meth)acrylate groups. It is also possible to vary the order of addition of the reagents, as described in the literature. For example, a (meth)acrylate comprising a hydroxyl group can first react with a polyisocyanate in order to obtain a (meth)acrylate functionalized with an isocyanate, which is then reacted with a polyol. Alternatively, all the reagents can react at the same time.

Examples of suitable polyester (meth)acrylates include the reaction products of acrylic acid, of methacrylic acid or of a mixture thereof with a polyester polyol. The reaction can be carried out in such a way that residual hydroxyl groups remain or else in such a way that all the hydroxyl groups are (meth)acrylated. The polyester polyols can in particular be obtained by polycondensation between a polyol (for example a diol) and a polycarboxylic acid (for example a dicarboxylic acid or an anhydride). In order to obtain a polyester (meth)acrylate, the hydroxyl groups of the polyester polyol are partially or totally esterified by reaction with (meth)acrylic acid, (meth)acryloyl chloride or (meth)acrylic anhydride. The polyester (meth)acrylates can also be obtained by reacting a (meth)acrylate comprising a hydroxyl group, such as hydroxyethyl (meth)acrylate or hydroxypropyl (meth)acrylate, with a polycarboxylic acid. The polyols and polycarboxylic acids can have linear or branched, aliphatic or aromatic, acyclic or cyclic structures.

According to one particular embodiment, the component F) is an aliphatic, cycloaliphatic or aromatic urethane diacrylate, more particularly an aliphatic urethane diacrylate. An example of a suitable aliphatic urethane diacrylate is available from Arkema under the reference CN966.

Examples of suitable polyether (meth)acrylates include the reaction products of acrylic acid, of methacrylic acid or of a mixture thereof with a polyether polyol. The polyether polyols can be linear or branched. The polyether polyols can be obtained by ring-opening polymerization of epoxides (for example ethylene oxide, 1,2-propylene oxide or 1-butene oxide) or of other heterocyclic compounds containing oxygen (for example oxetane or tetrahydrofuran). The polyether polyols can also be obtained by condensation of diols, such as glycols.

The oligomers described above can be modified with an amine or a thiol according to the procedures described in the literature. Such modified oligomers can in particular be obtained by reacting a low proportion of the (meth)acrylate groups (for example 2-15%) of the oligomer with an amine (for example a secondary amine) or a thiol, the amine or the thiol adding to the C═C double bond of some of the (meth)acrylate groups by a Michael addition reaction.

The composition according to the invention comprises 5 to 80%, in particular 8 to 55%, more particularly 15 to 40%, by weight of component F) relative to the weight of all the components A) to I).

Component G)

The composition according to the invention may comprise a component G). The composition may comprise a mixture of components G).

The component G) is an ethylenically unsaturated compound different from the components A) to F).

In particular, the component G) may be a compound comprising from 1 to 10 ethylenically unsaturated groups chosen from acrylate, methacrylate, vinyl, allyl, and mixtures thereof.

The component G) may in particular be chosen from:
di(meth)acrylates having a weight-average molecular weight Mw of greater than 650 g/mol and less than or equal to 700 g/mol;
tri(meth)acrylates and tetra(meth)acrylates having a weight-average molecular weight Mw of greater than 600 g/mol and less than or equal to 700 g/mol;
N-vinyl compounds, such as N-vinylpyrrolidone (NVP), N-vinylcaprolactam (NVC), N-vinylimidazole, N-vinyl-N-methylacetamide (VIMA);
O-vinyl compounds, such as ethyl vinyl ether, n-butyl vinyl ether, isobutyl vinyl ether, tert-butyl vinyl ether, cyclohexyl vinyl ether (CHVE), 2-ethylhexyl vinyl ether (EHVE), dodecyl vinyl ether (DDVE), octadecyl vinyl ether (ODVE), 1,4-butanediol divinyl ether (BDDVE), diethylene glycol divinyl ether (DVE-2), triethylene glycol divinyl ether (DVE-3), 1,4-cyclohexanedimethanol divinyl ether (CHDM-di);
hydroxyvinyl compounds, such as hydroxybutyl vinyl ether (HBVE), 1,4-cyclohexanedimethanol monovinyl ether (CHDM-mono);
other vinyl compounds such as 1,2,4-trivinylcyclohexane (TVCH);
(meth)acrylate/vinyl ether mixed compounds, such as 2-(2-vinyloxyethoxy)ethyl acrylate (VEEA), 2-(2-vinyloxyethoxy)ethyl methacrylate (VEEM).

The composition according to the invention comprises 0 to 30%, in particular 0 to 20%, by weight of component G) relative to the weight of all the components A) to I).

Component H)

The composition according to the invention may comprise a component H). The composition may comprise a mixture of components H).

The component H) is an initiator. An initiator is a compound which generates radicals when it is heated and/or subjected to radiation and/or subjected to an oxidation-reduction reaction.

According to one particular embodiment, the initiator is a peroxide. In this case, the composition according to the invention may be crosslinkable via the thermal route or at low temperature in the presence of a peroxide-reducing accelerator. The accelerator makes it possible in particular to accelerate the decomposition of the peroxide at low temperature (in particular at ambient temperature: 20-25° C.).

Alternatively, the composition according to the invention may comprise a photoinitiator. A photoinitiator is an initiator which generates radicals when it is subjected to radiation. In this case, the composition according to the invention may be crosslinkable by radiation, in particular by UV, near-UV, visible, infrared or near-infrared rays, by laser or by LED, preferably with a near-UV/visible lamp. The wavelength range which corresponds to the near-UV/visible radiation extends from 355 to 415 nm and that which corresponds to the visible radiation extends from 400 to 800 nm.

According to another alternative option, the composition according to the invention does not comprise any initiator and, in this case, it may be crosslinkable by radiation with an electron beam.

Preferably, the composition according to the invention comprises a photoinitiator.

According to another alternative, the composition of the invention is crosslinkable by a dual route, which means that it combines at least two crosslinking techniques as defined above.

Mention may be made, as examples of dual routes under this alternative definition, of the combination of a route based on the presence of a peroxide with that where at least one photoinitiator is present. In such a case, the composition can be crosslinked either simultaneously or in successive stages by the thermal route or at low temperature in the presence of peroxide or by the route under UV radiation with the additional presence of a photoinitiator. For example, a rapid crosslinking by the UV route in the presence of a photoinitiator can be followed by an additional crosslinking by the thermal route as a result of the presence of a peroxide with said photoinitiator, thus making it possible to round off/complete the crosslinking, in particular at a temperature greater than that of the UV crosslinking. This can in particular be advantageous when the glass transition temperature of the completely crosslinked composition is greater than that of the UV crosslinking temperature.

As examples of suitable peroxides, mention may in particular be made of: a hydroperoxide (R—O—O—H); a dialkyl peroxide, a diaryl peroxide or an aryl/alkyl peroxide (R—O—O—R′); a peroxyacid (RC(O)—O—O—H); a peroxyester (RC(O)—O—O—R′); a diacyl peroxide (RC(O)—O—O—C(O)—R′), a peroxyacetal, a peroxycarbonate, and mixtures thereof, R and R′ being independently aliphatic, cycloaliphatic or aromatic groups.

Mention may in particular be made, as examples of decomposition (reducing) accelerators of peroxides or hydroperoxides, of: tertiary amines and/or reducing agents containing transition metal salts, such as iron, cobalt, manganese or vanadium carboxylates.

Mention may in particular be made, as examples of suitable photoinitiators, of benzoins, benzoin ethers, acetophenones, benzils, benzil ketals, anthraquinones, acylphosphine oxides, α-hydroxy ketones, phenylglyoxylates, α-amino ketones, benzophenones, thioxanthones, xanthones, quinoxaline derivatives and triazine compounds. More particularly, the photoinitiator can be chosen from 2-methylanthraquinone, 2-ethylanthraquinone, 2-chloroanthraquinone, 2-benzylanthraquinone, 2-(t-butyl)anthraquinone, 1,2-benzo-9,10-anthraquinone, benzils, benzoins, benzoin ethers, benzoin methyl ether, benzoin ethyl ether, benzoin isopropyl ether, α-methylbenzoin, α-phenylbenzoin, Michler's ketones, acetophenones, benzophenones, benzophenone, 4,4′-bis(diethylamino)benzophenone, acetophenone, 2,2-diethoxyacetophenone, 4-ethoxyacetophenone, 2-isopropylthioxanthone, thioxanthone, diethylthioxanthone, 1,5-acetonaphthylene, ethyl p-dimethylaminobenzoate, (2,4,6-trimethylbenzoyl)diphenylphosphine oxide, 2,2-dimethoxy-1,2-diphenylethanone, 1-hydroxycyclohexyl phenyl ketone, 2-methyl-1-[4-(methylthio)phenyl]-2-morpholinopropan-1-one, 2-hydroxy-2-methyl-1-phenylpropanone, oligomeric α-hydroxy ketone, benzoylphosphine oxides, phenylbis(2,4,6-trimethylbenzoyl)phosphine oxide, ethyl 4-(dimethylamino)benzoate, ethyl (2,4,6-trimethylbenzoyl)phenylphosphinate, anthraquinone, (benzene)tricarbonylchromium, benzil, benzoin isobutyl ether, 3,3′,4,4′-benzophenonetetracarboxylic dianhydride, 4-benzoylbiphenyl, 2-benzyl-2-(dimethylamino)-4′-morpholinobutyrophenone, 4,4′-bis(diethylamino)benzophenone, 4,4′-bis(dimethylamino)benzophenone, camphorquinone, 2-chlorothioxanthen-9-one, dibenzosuberenone, 4,4′-dihydroxybenzophenone, 2,2-dimethoxy-2-phenylacetophenone, 4-(dimethylamino)benzophenone, 4,4′-dimethylbenzil, 2,5-dimethylbenzophenone, 3,4-dim ethylbenzophenone, 4′-ethoxyacetophenone, (2,4,6-trimethylbenzoyl)diphenylphosphine oxide, phenylbis(2,4,6-trimethylbenzoyl)phosphine oxide, ferrocene, 3′-hydroxyacetophenone, 4′-hydroxyacetophenone, 3-hydroxybenzophenone, 4-hydroxybenzophenone, 1-hydroxycyclohexyl phenyl ketone, 2-hydroxy-2-methylpropiophenone, 2-methylbenzophenone, 3-methylbenzophenone, methylbenzoyl formate, 2-methyl-4′-(methylthio)-2-morpholinopropiophenone, phenanthrenequinone, 4′-phenoxyacetophenone, (cumene)cyclopentadienyliron(II) hexafluorophosphate, 9,10-diethoxy- and 9,10-dibutoxyanthracene, 2-ethyl-9,10-dimethoxyanthracene, thioxanthen-9-one or any combination of the abovementioned initiators.

The composition according to the invention comprises 0.5 to 10% by weight of component H) relative to the weight of all the components A) to I).

Component I)

The composition according to the invention may comprise a component I). The composition may comprise a mixture of components I).

The component I) is an additive.

Examples of additives include antioxidants, photostabilizers, light absorbers, polymerization inhibitors, antifoam agents, antistatic agents, levelling agents, dispersants (wetting agents, surfactants), glide agents, adhesion promoters, lubricants, pigments, dyes, fillers, chain-transfer agents, rheological agents (thixotropic agents, thickeners), mattifying agents, opacifiers, impact resistance agents, waxes and any other agent commonly used in ink, coating, sealant, adhesive, molding, inking plate and 3D printing compositions.

The composition according to the invention comprises 0 to 30% by weight of component I) relative to the weight of all the components A) to I).

Composition

The composition according to the invention comprises:
5 to less than 50%, in particular 10 to 40%, more particularly 15 to 30%, of component A);
10 to 75%, in particular 15 to 70%, more particularly 20 to 60%, of component B);
0 to less than 45%, in particular 1 to 40%, more particularly 2 to 20%, of component C);
0 to 30%, in particular 0 to 20%, of component D);
0 to 30%, in particular 0 to 20%, of component E);
5 to 80%, in particular 8 to 55%, more particularly 15 to 40%, of component F);
0 to 30%, in particular 0 to 20%, of component G);
0.5 to 10% of component H);
0 to 30% of component I);
the % being % by weight relative to the weight of all the components A) to I).

According to one embodiment, the composition does not comprise a compound other than the compounds A) to I). Thus, the weight of all the components A) to I) can represent 100% of the weight of the composition.

The total weight of the components A) and C) represents less than 50% of the weight of all the components A) to I).

According to one embodiment, the total weight of the components A) and B) represents 30 to 90%, in particular from 35 to 85%, more particularly from 40 to 80%, more particularly still from 40 to 75%, of the weight of all the components A) to H).

In certain cases, the total weight of the components A) and B) represents 40 to 90%, in particular from 50 to 90%, more particularly from 60 to 90%, more particularly still from 70 to 90%, more particularly 80 to 90%, of the weight of all the components A) to H).

The weight ratio between the components A) and B) can in particular be from 0.1 to 5, in particular 0.2 to 2, more particularly 0.3 to 1.5, more particularly still 0.4 to 1, even more particularly 0.5 to 0.8.

In certain cases, the weight ratio between the components A) and B) ranges from 0.1 to 1, in particular 0.1 to 0.8, more particularly 0.1 to 0.7, more particularly still 0.1 to 0.6, even more particularly 0.2 to 0.6.

The weight ratio of the components A) to F) can in particular be adjusted so that the Tg of the composition is such that the final product has good mechanical properties and optionally a flexible and/or elastomeric nature.

According to one particular embodiment, the composition according to the invention has a Tg of from 0 to 30° C., in particular from 5 to 25° C. The Tg can be measured according to the method described below.

The weight ratio of the components A) to F) can be adjusted so that the composition has a suitable viscosity as a function of the intended application.

According to one particular embodiment, the composition according to the invention has a viscosity at 50° C. of from 1 to 20 mPa·s, in particular from 5 to 15 mPa·s.

The composition according to the invention can in particular be an ink, coating, sealant, adhesive, molding or inking plate composition or a composition for 3D printing.

According to one preferred embodiment, the composition according to the invention is a composition for 3D printing.

The composition according to the invention can in particular be used to obtain a crosslinked object and a 3D object according to the processes described below.

Process for Producing a Crosslinked Product and a 3D Object

The process for producing a crosslinked product comprises the crosslinking of the composition according to the invention. In particular, the composition can be crosslinked by exposing the composition to radiation and/or by heating the composition and/or by subjecting the composition to an oxidation-reduction reaction. More particularly, the composition can be crosslinked by exposing it to UV, near-UV, visible, infrared or near-infrared rays or to an electron beam.

The composition can be applied to a substrate or poured into a mold before being crosslinked.

The crosslinked product obtained can be an ink, a coating, a sealant, an adhesive, a molded material, an inking plate or a 3D object. In particular, the crosslinked product can be a 3D object.

The 3D object can in particular be obtained with a process comprising the printing of a 3D object using the composition according to the invention. The process can in particular be a process for continuous or layer-by-layer printing of a 3D object.

The process according to the invention can be carried out in most 3D printing techniques. The process can in particular be a tank or inkjet 3D printing process.

The process can in particular be a 3D printing process in which the composition according to the invention is contained in a tank and selectively cured (either in a plane or in space) by light-activated polymerization. This process is in particular described in standard ISO 52900 (2015). This process includes the various selective polymerization techniques induced by scanning with a light beam (stereolithography—SLA), projection of light images (Digital light processing—DLP) or exposure to light patterns derived from an LCD screen (liquid crystal device—LCD sometimes also referred to as masked stereolithography —MSLA) or any other process which exposes the resin to a light of which the wavelength induces the triggering of polymerization at a very precise site in the tank and limited solely to this site.

Alternatively, the process can be a 3D printing process in which the composition according to the invention is projected in drop form or deposited in the form of a ribbon, before being crosslinked under the effect of radiation. The composition can be projected onto a support, onto the prior layers or onto a layer of powdery substrate.

A “layer-by-layer” 3D printing process comprises the following steps:

a) depositing, on a surface, a first layer of composition according to the invention,

b) crosslinking the first layer, at least partially, in order to obtain a first crosslinked layer,

c) depositing, on the first crosslinked layer, a second layer of composition according to the invention,

d) crosslinking the second layer, at least partially, in order to obtain a second crosslinked layer, which is stuck to the first crosslinked layer; and

e) repeating steps c) and d) the number of times necessary in order to obtain the 3D object.

The crosslinking routes which can be used are those already described above with a particular preference for the techniques for crosslinking by actinic radiation (UV, UV/visible, near-UV/visible or electron beam EB) in the presence of a photoinitiator.

The composition according to the invention can also be used in processes for the production of 3D objects according to a continuous process also known as a CLIP (Continuous Liquid Interface (or Interphase) Product (or Printing)) method or process. This type of process is described in WO 2014/126830, WO 2014/126834 and WO 2014/126837 and in Tumbleston et al., “Continuous Liquid Interface Production of 3D Objects”, Science, Vol. 347, Issue 6228, pp. 1349-1352 (Mar. 20, 2015).

The CLIP process proceeds by projection of a film or of a continuous sequence of images by actinic radiation, for example UV radiation, which images can be generated, for example, by a digital imaging unit, through a window transparent to actinic radiation and permeable to oxygen (inhibitor), located under a bath of the composition maintained in liquid form. A liquid interface below the (growing) article is maintained by the dead zone created above the window. The cured solid article is continuously extracted from the bath of composition above the dead zone, which can be regenerated by introducing, into the bath, additional amounts of the composition in order to compensate for the amounts of composition which are cured and incorporated in the growing article.

For example, a process for printing a 3D object using the composition according to the invention can comprise the following steps:

a) providing a support (or print platen) and an optically transparent element having a construction surface, the support and the construction surface defining, between them, a construction region,

b) filling the construction region with the composition according to the invention,

c) continuously or intermittently irradiating the construction region with actinic radiation, in order to form, starting from the composition, a crosslinked composition, and

d) continuously or intermittently, moving said support away from the construction surface in order to form the 3D object with the crosslinked composition.

More particularly, the continuous printing process (CLIP type) can comprise the following steps:

a) providing a support (or print platen) and a stationary construction window, the construction window comprising a semipermeable element, said semipermeable element comprising a construction surface and a feed surface separate from the construction surface, the construction surface and the support defining, between them, a construction region, the feed surface being in liquid contact with a polymerization inhibitor,

b) then and at the same time and/or sequentially, filling the construction region with a composition according to the invention, said composition being in contact with the print platen,

c) irradiating the construction region through the construction window in order to produce a solid polymerized region in the construction region with a remaining layer of liquid film consisting of the composition, formed between the solid polymerized region and the construction window, the polymerization of the liquid film being inhibited by the polymerization inhibitor; and

d) moving the print platen, to which the polymerized region is stuck, away from the construction surface of the stationary window in order to create a construction region between the polymerized region and the stationary construction window.

Generally, this process includes a step e) of repeating and/or continuing steps b) to d) in order to subsequently produce a polymerized region stuck to a region polymerized previously, until the continuous or repeated deposition of polymerized regions stuck to one another forms the targeted 3D object.

The crosslinked products and 3D objects obtained with the processes according to the invention are described below.

Crosslinked Product and 3D Object

The crosslinked product according to the invention is obtained by crosslinking the composition as defined above or according to the process described above.

The crosslinked product can in particular be an ink, a coating, a sealant, an adhesive, a molded material, an inking plate or a 3D object, in particular the crosslinked product is a 3D object.

The 3D objects obtained with the process according to the invention are advantageously clean and detach easily from the platen. They can in particular have good tear resistance and resistance to folding.

According to one preferred embodiment, the 3D objects obtained are flexible and/or elastomeric. They can in particular have an elongation at break of 120 to 250%.

Uses

The composition according to the invention can be used for obtaining an ink, a coating, a sealant, an adhesive, a molded material, an inking plate or a 3D object, in particular a 3D object.

The invention also relates to the use of a mono(meth)acrylate comprising a 1,3-dioxolane ring in a composition for 3D printing. The mono(meth)acrylate comprising a 1,3-dioxolane ring can in particular correspond to the component A) described above.

The amount of component A) in the composition is advantageously from 5 to less than 50%, in particular 10 to 40%, more particularly 15 to 30%, by weight relative to the weight of the composition.

The mono(meth)acrylate comprising a 1,3-dioxolane ring can advantageously be combined with one or more mono(meth)acrylates different from the mono(meth)acrylate comprising a 1,3-dioxolane ring and/or with one or more oligomers comprising at least two (meth)acrylate groups and having a weight-average molecular weight Mw of greater than 700 g/mol. The mono(meth)acrylate(s) different from the mono(meth)acrylate comprising a 1,3-dioxolane ring can in particular correspond to the component B) described above. The oligomer(s) comprising at least two (meth)acrylate groups and having a weight-average molecular weight Mw of greater than 700 g/mol can in particular correspond to the component F) described above.

The amount of component B) in the composition is advantageously from 10 to 75%, in particular 15 to 70%, more particularly 20 to 60%, by weight relative to the weight of the composition.

According to one embodiment, the total weight of the components A) and B) represents 30 to 90%, in particular from 35 to 85%, more particularly from 40 to 80%, more particularly still from 40 to 75%, of the weight of the composition.

In certain cases, the total weight of the components A) and B) represents 40 to 90%, in particular from 50 to 90%, more particularly from 60 to 90%, more particularly still from 70 to 90%, more particularly 80 to 90%, of the weight of the composition.

The weight ratio between the components A) and B) can in particular be from 0.1 to 5, in particular 0.2 to 2, more particularly 0.3 to 1.5, more particularly still 0.4 to 1, even more particularly 0.5 to 0.8.

In certain cases, the weight ratio between the components A) and B) ranges from 0.1 to 1, in particular 0.1 to 0.8, more particularly 0.1 to 0.7, more particularly still 0.1 to 0.6, even more particularly 0.2 to 0.6.

The amount of the component F) in the composition is advantageously from 5 to 80%, in particular 8 to 55%, more particularly 15 to 40%, by weight relative to the weight of the composition.

The composition can also comprise a component chosen from a component C), a component D), a component E), a component G), a component H), a component I), and mixtures thereof, as described above.

The amount of the component C) in the composition can be from 0 to less than 45%, in particular 1 to 40%, more particularly 2 to 20%, by weight relative to the weight of the composition.

The total weight of the components A) and C) can represent less than 50% of the weight of the composition.

The amount of the component D) in the composition can be from 0 to 30%, in particular 0 to 20%, by weight relative to the weight of the composition.

The amount of the component E) in the composition can be from 0 to 30%, in particular 0 to 20%, by weight relative to the weight of the composition.

The amount of the component G) in the composition can be from 0 to 30%, in particular 0 to 20%, by weight relative to the weight of the composition.

The amount of the component H) in the composition can be from 0.5 to 10% by weight relative to the weight of the composition.

The amount of the component I) in the composition can be from 0 to 30% by weight relative to the weight of the composition.

According to one embodiment, the composition does not comprise a compound other than the compounds A) to I). Thus, the weight of all the components A) to I) can represent 100% of the weight of the composition.

The invention is illustrated by the following non-limiting examples.

### EXAMPLES

Measurement Methods

The measurement methods used in the present application are described below:

Glass Transition Temperature:

The glass transition temperature is obtained by dynamic mechanical analysis (DMA). The storage modulus (G′) and the loss modulus (G″) are measured on a Rheometric Scientific RDA III instrument controlled by the RSI Orchestrator software, with a temperature increase of from −40° C. to 180° C. at a rate of 3° C./min, by applying a rectangular torsional stress to a printed sample according to the printable object file of FIG. 2 having dimensions of 80×10×4 mm (useful length between jaws adjustable between 1.5 and 4 cm, this value being taken into account in the calculation of the moduli by the software) with a typical rate of deformation of 0.05% (adjustable according to the response of the material) and a stress frequency of 1 Hz. Preferably, the samples were subjected beforehand to conditioning for at least 24 h at 23° C.+/−2° C. and with a relative humidity of 50%+/−10%. The storage modulus values can be given at various temperatures, in particular at 25° C. and at 150° C. The G″/G′ ratio is called the loss factor or tangent delta (tan delta). The Tg corresponds to the temperature for which the value of this tangent is at its maximum (Ta). This method makes it possible in particular to measure the glass transition temperature of polymeric materials for which direct measurement by DSC (differential scanning calorimetry) is impossible or difficult to determine.

Surface Tension:

The surface tension is measured by the hanging drop method with a DSA10 (Drop Shape Analysis) device from Krüss. The measurements were carried out at 23° C. with 50% humidity. The drops are formed at the tip of a syringe in air. For a drop at equilibrium, the Laplace equation links the shape of the drop to the surface tension and gravity. The software of the device can extract the profile of the drop and the corresponding parameters (in particular the radius of curvature and the aspect ratio). The density of the compound is measured with a pycnometer. The surface tension is calculated according to the following formula:

surface tension IFT=(ρ_{liquid}−ρ_{medium})g×Ro×2/β

ρ_{liquid}=density of the liquid

ρ_{medium}=density of the surrounding medium

Ro=radius of curvature of the drop

β=aspect ratio of the drop

Viscosity:

The viscosity is measured at 50° C. with a Brookfield viscometer (Fungilab alpha series) equipped with an S27 cylindrical spindle rotating up to 100 rpm. The temperature is kept constant with a water-circulation temperature regulation system.

Weight-Average Molecular Weight

The weight-average molecular weight is determined by size exclusion chromatography (SEC) according to OECD (1996), Test No. 118: Determination of the Number-Average Molecular Weight and the Molecular Weight Distribution of Polymers using Gel Permeation Chromatography, OECD Guidelines for the Testing of Chemicals, Section 1, Éditions OCDE [OECD Publications], Paris. The following conditions are used:
two mixed columns D (ref. 1110-6504)+one 100 Å column (ref. 1110-6520)+one 50 Å column (ref. 1110-6515), (7.8 mm×300 mm) supplied by Agilent, the stationary phase being a polystyrene-divinylbenzene (PS-DVB) crosslinked gel
mobile phase (THF) flow rate: 1 ml/min
column temperature: 35° C.
detector: refractive index
calibration: polystyrene standards (Mw: 483 400, 215 000, 113 300, 51 150, 19 540, 10 110, 4430, 2930, 1320, 575, 162 g/mol).

Printability:

The quality of the printing of a 3D object is determined visually on an object printed according to the printable object file of FIG. 4 and a score of 0 to 5 is assigned according to the following scale:

0: no object prints

1: the object is completely or partially detached from the platform

2: the object is delaminated (a portion of the layers is missing)

3: the printing of flat objects is correct, but some shapes are missing or deformed in the complex objects: crushed reliefs, fused parallel walls

4: the printing of simple geometric parts is good, but the details that are the most difficult to print (overhangs and gantries) are missing

5: all the details of all the parts are present

Tensile Test (Elongation, Breaking Stress)

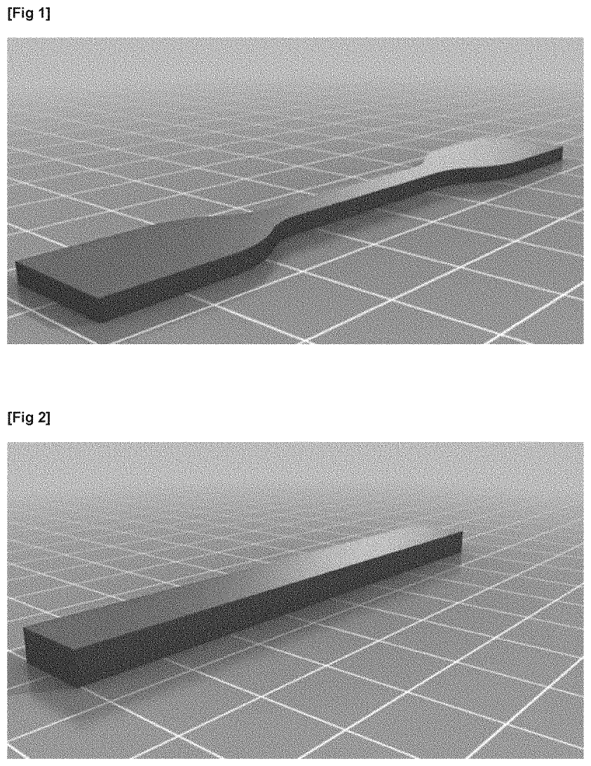

The elongation and the breaking stress are obtained on a printed object according to the printable object file of FIG. 1 with a tensile test according to standard ISO 527-5A: 1993 with a tensile speed of 500 mm/min.

Tear Resistance

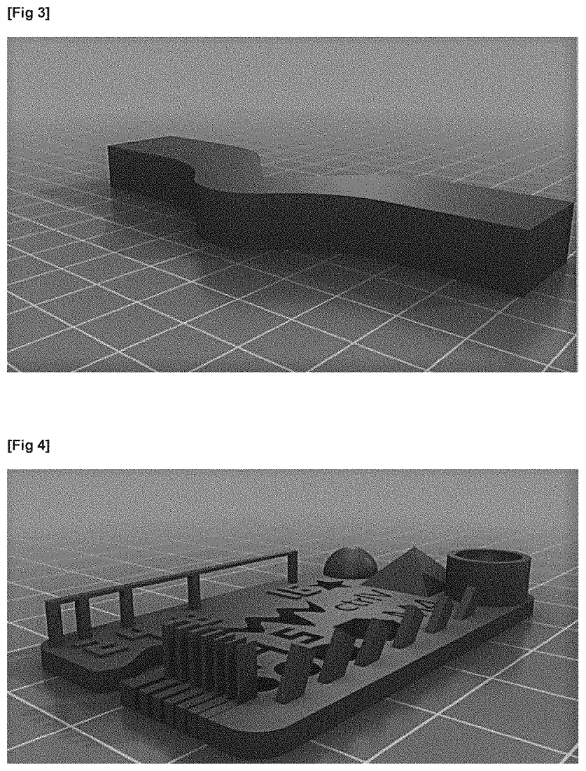

The tear resistance is obtained on a printed object according to the printable object file of FIG. 3 according to standard D624 type C, 2012 with a tensile speed of 500 mm/min.

Hardness

The hardness was measured on a printed object according to the printable object file of FIG. 1 according to standard ISO 868: 2003 with a durometer of Shore A type. The measurements were taken after 5 seconds of contact between the measurement tip and the sample.

Materials

The materials used in the examples are described below:

CN966: aliphatic urethane diacrylate having a weight-average molecular weight of 7000 g/mol, available from Arkema under the reference CN966H90 (commercial mixture containing 90% by weight of CN966 and 10% by weight of SR256 relative to the weight of the mixture)

IPGA: 2,2-dimethyl-1,3-dioxolan-4-yl)methyl acrylate obtained by trans-esterification reaction between isopropylidene glycerol (Augeo SL 191, Solvay) and methyl acrylate (Arkema), with an acrylate/alcohol molar ratio of 2 to 3, catalysed with zirconium acetylacetonate (Zr(AcAc)₄, Sachem). The trans-esterification reaction is carried out (8 h) by adding the catalyst to the reaction medium with mechanical stirring and by slightly reducing the pressure within the reactor in order to maintain a reaction temperature below 100° C. The reaction by-product (methanol) is extracted by distillation via reflux of a methanol/methyl acrylate azeotrope. The residual methyl acrylate is removed by stripping at reduced pressure (<100 mbar, 1 h 30). The desired reaction product IPGA is purified by distillation at low pressure (<15 mbar, 3 h).

SR495B: polycaprolactone monoacrylate (2-[O—(CH₂)₅—C(═O)]— units) having a weight-average molecular weight of 344 g/mol, sold under the reference SR495B by Arkema

SR506D: isobornyl acrylate having a molecular weight of 208 g/mol, sold under the reference SR506D by Arkema

SR256: 2(2-ethoxyethoxy)ethyl acrylate having a molecular weight of 188 g/mol, sold under the reference SR256 by Arkema

TPO-L: ethyl(2,4,6-trimethylbenzoyl)phenyl phosphinate sold under the reference SpeedCure® TPO-L by Lambson

BPO: phenyl bis(2,4,6-trimethylbenzoyl)phosphine oxide sold under the reference

SpeedCure® BPO by Lambson

### Example 1: Compositions

Compositions are prepared using the compounds detailed in the table below (the amounts are indicated as % by weight relative to the weight of the composition, the amount of CN966 corresponds to the actual amount of oligomer, and the amount of SR256 corresponds to the amount of monomer introduced by the commercial mixture CN966H90).

TABLE 1

| | A) | B) | | | F) | G) | |
|---|---|---|---|---|---|---|---|
| Component | IPGA | SR495B | SR506D | SR256 | CN966 | TPO-L | BPO |
| M001 (Comp) | 35 | 0 | 0 | 6 | 54 | 5 | 0 |
| K049 | 15 | 20 | 0 | 6 | 54 | 5 | 0 |
| K023 | 45 | 0 | 20 | 3 | 27 | 5 | 0 |
| K040 | 15 | 25 | 25 | 3 | 27 | 5 | 0 |
| K022 | 45 | 0 | 30 | 2 | 18 | 5 | 0 |
| K048 | 25 | 25 | 35 | 1 | 9 | 5 | 0 |
| M002 (Comp) | 53 | 0 | 35 | 1 | 9 | 0 | 2 |
| K054 | 28 | 20 | 40 | 1 | 9 | 0 | 2 |

The monofunctional monomers (IPGA, SR495B and/or SR506D) and the oligomer (CN966 as a mixture with SR256) are preheated separately at 65° C. The oligomer is introduced, with manual stirring, into one of the monofunctional monomers (the most predominant in terms of %) and homogenized. The rest of the monomers are then added to the mixture. The photoinitiator (TPO-L or BPO) is introduced last. The temperature of the mixture is allowed to fall back to ambient temperature (20-25° C.).

### Example 2: 3D Objects

3D Objects were printed using the compositions of Example 1 according to the printable object file, represented in FIGS. 1-4. The printing operations were carried out on a 3D printer, Photon model (Anycubic LCD printer). The printing programme used for each example is detailed in the table below (the adhesion layers are the layers in contact with the platform, also called “bottom layers”). The parts obtained after printing are subjected to post-curing under a 12 V LED lamp equipped with a conveyor bench with 10 passes at the speed of 5 m/min.

TABLE 2

| | exposure | pause time | adhesion layer | number |
|---|---|---|---|---|
| | time per | between | exposure | of |
| | layer | layers | time | adhesion |
| | (s) | (s) | (s) | layers |
| M001 (Comp) | non-printable | | | |
| K049 | 30 | 6 | 120 | 3 |
| K023 | 30 | 5 | 30 | 3 |
| K040 | 30 | 6 | 120 | 3 |
| K022 | 30 | 5 | 30 | 3 |
| K048 | 30 | 6 | 120 | 3 |
| M002 (Comp) | non-printable | | | |
| K054 | 60 | 10 | 120 | 3 |

The properties of the objects obtained are detailed in the table below:

TABLE 3

| | | Breaking | | Tear | |
|---|---|---|---|---|---|
| | | stress | Elongation | resistance | Hardness |
| | Printability | (MPa) | (%) | (N/mm) | (ShoreA) |
| M001 (Comp) | 0 | N.D | N.D | N.D | N.D |
| K049 | 5 | 1.2 | 76 | 11.5 | 43 |
| K023 | 2 | 1.7 | 230 | 4 | 36 |
| K040 | 5 | 2.7 | 101 | 2.5 | 39 |
| K022 | 2 | 7.5 | 330 | 8 | 52 |
| K048 | 5 | 1.1 | 143 | 5 | 34 |
| M002 (Comp) | 0 | N.D | N.D | N.D | N.D |
| K054 | 5 | 2.7 | 180 | N.D | 45 |

The objects printed with the compositions K049, K040, K048 and K054 according to the invention are of good quality and all the details of the model part are present. These objects also exhibit good elongation, a flexible and pleasant feel and suitable mechanical properties. These objects are obtained with compositions comprising 40 to 90% by weight of component A) and of component B) relative to the weight of the composition and having a weight ratio between the component A) and the component B) of from 0.2 to 0.6.

The objects printed with the compositions K022 and K023 according to the invention exhibit excellent elongation, but are delaminated (a portion of the layers is missing). These objects are obtained with compositions comprising 40 to 90% by weight of component A) and of component B) relative to the weight of the composition and having a weight ratio between the component A) and the component B) of from 1.4 to 2.0. These examples show that the use of a component B) comprising at least 15% by weight of soft and hydrophilic monomer, such as polycaprolactone acrylate and 2-(2-ethoxyethoxy)ethyl acrylate, relative to the weight of the component B), makes it possible to improve the quality of the 3D printing of flexible and elastomeric objects.

No object could be printed with the comparative composition M001, which does not comprise a sufficient amount of component B).

No object could be printed with the comparative composition M002, which comprises too high an amount of component A).

1. A composition comprising:
a) 5 to less than 50%, in particular 10 to 40%, more particularly 15 to 30%, of a component A) which is a mono(meth)acrylate comprising a 1,3-dioxolane ring;
b) 10 to 75%, in particular 15 to 70%, more particularly 20 to 60%, of a component B) which is a mono(meth)acrylate different from A);
c) 0 to less than 45%, in particular 1 to 40%, more particularly 2 to 20%, of a component C) which is a di(meth)acrylate having a weight-average molecular weight Mw of less than or equal to 650 g/mol;
d) 0 to 30%, in particular 0 to 20%, of a component D) which is a tri(meth)acrylate having a weight-average molecular weight Mw of less than or equal to 600 g/mol;
e) 0 to 30%, in particular 0 to 20%, of a component E) which is a tetra(meth)acrylate having a weight-average molecular weight Mw of less than or equal to 600 g/mol;
f) 5 to 80%, in particular 8 to 55%, more particularly 15 to 40%, of a component F) which is an oligomer comprising at least two (meth)acrylate groups and having a weight-average molecular weight Mw of greater than 700 g/mol;
g) 0 to 30%, in particular 0 to 20%, of a component G) which is an ethylenically unsaturated compound different from the components A) to F);
h) 0.5 to 10% of a component H) which is an initiator;
i) 0 to 30% of a component I) which is an additive;
the % being % by weight relative to the weight of all the components A) to I);
on the condition that the total weight of the components A) and C) represents less than 50% of the weight of all the components A) to I).

2. The composition as claimed in claim 1, in which the total weight of the components A) and B) represents 30 to 90%, in particular from 35 to 85%, more particularly from 40 to 80%, more particularly still from 40 to 75%, of the weight of all the components A) to H).

3. The composition as claimed in claim 1 or 2, in which the weight ratio between the components A) and B) is from 0.1 to 5, in particular 0.2 to 2, more particularly 0.3 to 1.5, more particularly still 0.4 to 1, even more particularly 0.5 to 0.8.

4. The composition as claimed in any one of claims 1 to 3, in which the component A) corresponds to formula (I) below: 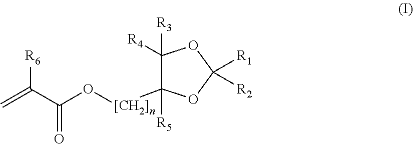
in which
R₁ and R₂ are independently chosen from H, C₁-C₆ alkyl, C₅-C₁₂ cycloalkyl and alkylaryl;
R₃, R₄, R₅ and R₆ are independently H or methyl;
n is 1, 2, 3, 4 or 5;
in particular, the component A) corresponds to formula (I) in which
R₁ and R₂ are independently chosen from H, methyl and ethyl, preferably R₁ and R₂ are methyl;
R₃, R₄ and R₅ are H;
R₆ is H or methyl, preferably R₆ is H;
n is 1;
more particularly, the component A) is represented by formula (Ia) below:

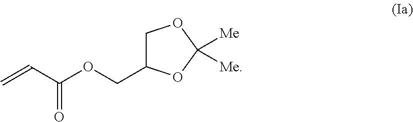

5. The composition as claimed in any one of claims 1 to 4, in which the component B) corresponds to formula (II) below: 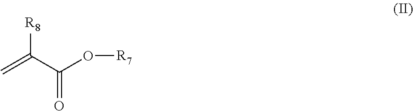
in which
R₇ is the residue of a monoalcohol or polyol chosen from a monoalcohol or polyol of polyether type, a monoalcohol or polyol of polyester type, a monoalcohol or polyol of polycarbonate type, an aliphatic monoalcohol or polyol, a cycloaliphatic monoalcohol or polyol, an aromatic monoalcohol or polyol, and the alkoxylated, in particular ethoxylated and/or propoxylated, derivatives of said monoalcohols or polyols;
R₈ is H or methyl, in particular R₈ is H.

6. The composition as claimed in any one of claims 1 to 5, in which the component B) is chosen from a soft and hydrophilic mono(meth)acrylate, a soft and hydrophobic mono(meth)acrylate, a hard and hydrophilic mono(meth)acrylate, a hard and hydrophobic mono(meth)acrylate, and mixtures thereof;
in particular, the component B) comprises a soft and hydrophilic mono(meth)acrylate, optionally as a mixture with a hard and hydrophobic mono(meth)acrylate;
more particularly, the component B) comprises a soft and hydrophilic monoacrylate, optionally as a mixture with a hard and hydrophobic monoacrylate.

7. The composition as claimed in any one of claims 1 to 6, in which the component B) comprises a soft and hydrophilic monoacrylate comprising a hydroxyl group, in particular a polycaprolactone monoacrylate, optionally as a mixture with a monoacrylate having a Tg of greater than 40° C., in particular isobornyl acrylate.

8. The composition as claimed in any one of claims 1 to 6, in which the component B) comprises a mono(meth)acrylate having a surface tension of from 20 to 35 mN/m; in particular a mono(meth)acrylate chosen from tert-butylcyclohexyl acrylate, isobornyl acrylate, tricyclodecane methanol monoacrylate, isodecyl acrylate, trimethylcyclohexyl acrylate, trimethylcyclohexyl methacrylate, 2-ethylhexyl acrylate, isooctyl acrylate, octyldecyl acrylate, tridecyl acrylate, lauryl acrylate, ethoxylated lauryl acrylate (4 ethoxy units), isodecyl methacrylate, tert-butylcyclohexyl methacrylate, isobornyl methacrylate, tricyclodecane methanol monomethacrylate, a C₁₂-C₁₅ alkyl methacrylate such as lauryl methacrylate, and mixtures thereof; more particularly, the component B) is isobornyl acrylate.

9. The composition as claimed in any one of claims 1 to 8, in which the component C) corresponds to formula (III) below: 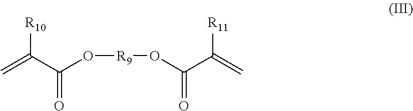
in which
R₉ is the residue of a polyol chosen from a polyether polyol, a polyester polyol, a polycarbonate polyol, an aliphatic polyol, a cycloaliphatic polyol, an aromatic polyol, a polybutadiene polyol, a polydialkylsiloxane polyol and the alkoxylated, in particular ethoxylated and/or propoxylated, derivatives of said polyols;
R₁₀ and R₁₁ are independently H or methyl, in particular R₁₀ and R₁₁ are H;
in particular, R₉ is the residue of a polyether polyol or of an aliphatic polyol that is optionally alkoxylated, in particular ethoxylated and/or propoxylated;
more particularly, R₉ is the residue of a polyethylene glycol.

10. The composition as claimed in any one of claims 1 to 9, in which the component F) is an oligomer chosen from a urethane (meth)acrylate, an epoxy (meth)acrylate, a polyether (meth)acrylate, a polyester (meth)acrylate, and mixtures thereof, in particular the component F) is an aliphatic urethane diacrylate.

11. The composition as claimed in any one of claims 1 to 10, characterized in that the composition has a Tg of from 0 to 30° C., in particular from 5 to 25° C.

12. The composition as claimed in any one of claims 1 to 11, characterized in that the composition has a viscosity at 50° C. of from 1 to 20 mPa·s, in particular from 5 to 15 mPa·s.

13. The composition as claimed in any one of claims 1 to 12, characterized in that the composition is an ink, coating, sealant, adhesive, molding or inking plate composition or a composition for 3D printing; in particular a composition for 3D printing.

14. A process for producing a crosslinked product, characterized in that it comprises the crosslinking of the composition as defined in any one of claims 1 to 13, in particular by exposing the composition to radiation, more particularly to UV, near-UV, visible, infrared or near-infrared rays or to an electron beam.

15. The process as claimed in claim 14, characterized in that the crosslinked product is an ink, a coating, a sealant, an adhesive, a molded material, an inking plate or a 3D object, in particular a 3D object.

16. A process for producing a 3D object, comprising the printing of a 3D object using the composition as defined in any one of claims 1 to 13; in particular the continuous or layer-by-layer printing of a 3D object.

17. A crosslinked product obtained by crosslinking the composition as defined in any one of claims 1 to 13 or according to the process described in any one of claims 14 to 16.

18. The crosslinked product as claimed in claim 17, characterized in that the crosslinked product is an ink, a coating, a sealant, an adhesive, a molded material, an inking plate or a 3D object, in particular a 3D object.

19. The use of a composition as defined in any one of claims 1 to 13, for obtaining an ink, a coating, a sealant, an adhesive, a molded material, an inking plate or a 3D object, in particular a 3D object.

20. The use of a mono(meth)acrylate comprising a 1,3-dioxolane ring in a composition for 3D printing.
